(19) United States
(12) Patent Application Publication
(10) Pub. No.: US 2011/0195309 A1
(43) Pub. Date: Aug. 11, 2011

(54) NONAQUEOUS ELECTROLYTE SECONDARY BATTERY

(75) Inventors: Fumiharu Nina, Kobe-shi (JP); Akihiro Suzuki, Kobe-shi (JP); Shingo Tode, Naruto-shi (JP); Toshikazu Yoshida, Kobe-shi (JP); Yoshinori Kida, Kobe-shi (JP); Hiroyuki Fujimoto, Kobe-shi (JP)

(73) Assignee: SANYO ELECTRIC CO., LTD., Osaka (JP)

(21) Appl. No.: 13/023,951

(22) Filed: Feb. 9, 2011

(30) Foreign Application Priority Data
Feb. 9, 2010 (JP) 2010-026048
Oct. 29, 2010 (JP) 2010-242877

(51) Int. Cl. H01M 4/52; H01M 4/50

(52) U.S. Cl. 429/223; 252/182.1

(57) ABSTRACT

A positive electrode active material of a nonaqueous electrolyte secondary battery is improved by using an inexpensive lithium transition metal oxide containing nickel and manganese as main components. Output characteristics of the battery under various temperature conditions are thereby improved, and the battery is suitable as a power supply of a hybrid vehicle. The battery includes a positive electrode including a positive electrode active material, a negative electrode including a negative electrode active material, and a nonaqueous electrolyte prepared by dissolving a solute in a nonaqueous solvent. The positive electrode active material includes positive electrode active material particles composed of a lithium transition metal complex oxide having a layered structure containing nickel and manganese as main components, and at least one niobium-containing material selected from a Li—Nb—O compound and a Li—Ni—Nb—O compound, the at least one niobium-containing material being sintered onto surfaces of the positive electrode active material particles.

### CROSS REFERENCE TO RELATED APPLICATIONS

This application claims priority to Japanese Patent Application No. 2010-242877, filed in the Japan Patent Office on Oct. 29, 2010, and claims priority to Japanese Patent Application No. 2010-26048, filed in the Japan Patent Office on Feb. 9, 2010, the entire contents of both which are incorporated herein by reference.

### BACKGROUND OF THE INVENTION

1. Field of the Invention

The present invention relates to a nonaqueous electrolyte secondary battery that includes a positive electrode containing a positive electrode active material, a negative electrode containing a negative electrode active material, and a nonaqueous electrolyte solution obtained by dissolving a solute in a nonaqueous solvent, and to a positive electrode active material used in the positive electrode of the nonaqueous electrolyte secondary battery. In particular, the present invention relates to a lithium transition metal complex oxide having a layered structure and containing Ni and Mn as main components, which is used as a positive electrode active material of a positive electrode of a nonaqueous electrolyte secondary battery, and to improvements on the positive electrode active material that enhance output characteristics under various temperature conditions and render it suitable for use in power supplies of hybrid electric vehicles and the like.

2. Description of Related Art

Recent years have seen notable advancement in the size and weight reduction of mobile appliances such as cellular phones, laptop computers, and personal digital assistants (PDAs). The energy consumption of these appliances is also increasing due to the increase in the number functions they perform. Thus, there has been an increasing need to reduce the weight and increase the capacity of nonaqueous electrolyte secondary batteries used as the power supplies for such appliances.

Also in recent years, in order to address environmental issues derived from automobile emission, gas-electric hybrid vehicles that use both gasoline engines and electric motors are being developed.

In general, nickel-hydride storage batteries are widely used as the power supplies of such electric vehicles. Studies are now being made on the usage of nonaqueous electrolyte secondary batteries as power supplies that achieve higher capacities and higher outputs.

Lithium transition metal complex oxides mainly composed of cobalt, such as lithium cobaltate (LiCoO₂) are mainly used as a positive electrode active material of a positive electrode of a nonaqueous electrolyte secondary battery.

However, cobalt used in such positive electrode active materials is a scarce resource and is expensive, and stable supply thereof is difficult. Since large quantities of cobalt will be needed if such materials are used in power supplies of hybrid vehicles, the cost of the power supplies will rise significantly.

Under such circumstances, studies have been made to investigate whether materials mainly composed of nickel and/or manganese instead of cobalt can be used as a less expensive positive electrode active material, the supply of which is stable.

For example, lithium nickelate (LiNiO₂) having a layered structure is regarded as a potential material for achieving a large discharge capacity, but it has disadvantages of a high overvoltage and a poor thermal stability at high temperatures.

Lithium manganate (LiMn₂O₄) having a spinel structure is less expensive since manganese is an abundant resource, but its energy density is low. Moreover, manganese tends to elute into a nonaqueous electrolyte solution in a high-temperature environment.

In recent years, much focus has been placed on lithium transition metal complex oxides having a layered structure containing two transition metals, i.e., nickel and manganese, as main components to reduce the cost and improve thermal stability.

For example, Japanese Unexamined Patent Application Publication No. 2007-12629 (Patent Document 1) proposes a lithium complex oxide that has a layered structure, contains nickel and manganese, and has a rhombohedral structure in which the margin of error in the atomic ratio of nickel to manganese is within 10 atom %. This lithium complex oxide has been proposed to be used as a positive electrode active material that has an energy density substantially equal to that of lithium cobaltate but does not result in decreased safety as with lithium nickelate or manganese elution into a nonaqueous electrolyte solution in a high temperature environment as with lithium manganese.

However, the lithium transition metal complex oxide disclosed in Patent Document 1 is significantly inferior to lithium cobaltate in terms of high-rate charge/discharge characteristics and is thus difficult to use in power supplies of electric vehicles and the like.

Japanese Patent No. 3571671 (Patent Document 2) proposes a lithium transition metal complex oxide having a layered structure containing at least nickel and manganese, and a single phase cathodic material including this lithium transition metal complex oxide in which nickel and manganese are partly substituted with cobalt.

However, the single phase cathodic material disclosed in Patent Document 2 still has a disadvantage of high cost if the amount of cobalt substituting part of nickel and manganese is large, and a disadvantage of a large drop in high-rate charge/discharge characteristics if the amount of cobalt is small.

Japanese Patent No. 3835412 (Patent Document 3) describes a positive electrode active material prepared by baking a lithium nickel complex oxide in the presence of niobium oxide or titanium oxide on the surface thereof. The document describes that when baking is conducted as such, a lithium nickel complex oxide having high thermal stability is obtained.

However, high-rate charge/discharge characteristics and low-temperature charge/discharge characteristics deteriorated and output characteristics under various temperature conditions did not improve when a lithium nickel complex oxide described in Patent Document 3 was used as a positive electrode active material of a nonaqueous electrolyte secondary battery, the lithium nickel complex oxide being prepared by baking a lithium nickel complex oxide, e.g., LiNi_{0.82}Co_{0.15}Al_{0.03}O₂, in the presence of niobium oxide or titanium oxide on the surface thereof as described in EXAMPLES of Patent Document 3.

Japanese Unexamined Patent Application Publication No. 2007-273448 (Patent Document 4) proposes a nonaqueous electrolyte secondary cell having an I-V resistance lowered by use of a positive electrode active material containing a lithium transition metal complex oxide which has a layered structure and to which a group IVa element and a group Va element are added.

However, even the use of a positive electrode active material containing a lithium transition metal complex oxide which has a layered structure and to which a group IVa element and a group Va element are added cannot sufficiently lower the I-V resistance. Moreover, when the cell is stored at a high temperature, the I-V resistance increases from the initial value. Thus, this material has not been suitable for use in a power supply for hybrid vehicles and the like.

### BRIEF SUMMARY OF THE INVENTION

An object of the present invention is to address various challenges that face a nonaqueous electrolyte secondary battery that includes a positive electrode containing a positive electrode active material, a negative electrode containing a negative electrode active material, and a nonaqueous electrolyte solution prepared by dissolving a solute in a nonaqueous solvent.

Another object of the present invention is to improve a positive electrode active material contained in a positive electrode of a nonaqueous electrolyte secondary battery, the positive electrode active material including an inexpensive lithium transition metal complex oxide having a layered structure containing nickel and manganese as main components, so that the output characteristics under various temperature conditions and after high-temperature storage can be improved. And to provide a battery using the positive electrode active material becomes suitable for use as a power supply of hybrid vehicles.

To address the challenges described above, a positive electrode active material for a nonaqueous electrolyte secondary battery is prepared by forming at least one niobium-containing material selected from a Li—Nb—O compound and a Li—Ni—Nb—O compound sintered on surfaces of positive electrode active material particles composed of a lithium transition metal complex oxide having a layered structure containing nickel and manganese as main components. The phrase “containing nickel and manganese as main components” means that the total ratio of nickel and manganese relative to the total amount of transition metals is over 50 mol %.

When the niobium-containing material such as a Li—Nb—O compound or a Li—Ni—Nb—O compound is sintered onto the positive electrode active material particles, the state shown in FIG. 1 is generated. That is, a solid solution portion 3 is created by sintering of the niobium-containing material 2 on a positive electrode active material particle 1. Atoms diffused by dissolution can be confirmed by subjecting a cross-section of the positive electrode active material particle 1 to energy dispersive X-ray fluorescence spectroscopy using a transmission electron microscope (TEM). When a niobium-containing material is simply added to a positive electrode active material or when the secondary baking temperature for sintering is low, the niobium-containing material 2 simply adheres on the positive electrode active material particle 1, as shown in FIG. 2, and no solid solution portion 3 is present.

The lithium transition metal complex oxide described above is preferably represented by general formula Li₁₊ₓNiₐMn_{b}Co_{c}O_{2+d} (where x, a, b, c, and d satisfy x+a+b+c=1, 0<x≦0.1, 0≦c/(a+b)<0.40, 0.7≦a/b≦3.0, and −0.1≦d≦0.1). More preferably, 0≦c/(a+b)<0.35 and 0.7≦a/b≦2.0 and yet more preferably 0≦c/(a+b)<0.15 and 0.7≦a/b≦1.5.

A reason for using a lithium transition metal complex oxide that has a cobalt content c, a nickel content a, and a manganese content b that satisfy 0≦c/(a+b)<0.40 in the general formula described above is to lower the cobalt ratio and reduce the raw material cost of the positive electrode active material. More preferably, 0≦c/(a+b)<0.35 and yet more preferably 0≦c/(a+b)<0.15.

According to the present invention, output characteristics of a nonaqueous electrolyte secondary battery in which a low-cobalt-content, low-cost lithium transition metal complex oxide is used as the positive electrode active material are improved under various temperature conditions so that the battery is suitable for use in a power supply of hybrid vehicles etc.

A reason for using a lithium transition metal complex oxide having a nickel content a and a manganese content b that satisfy 0.7≦a/b≦3.0 is as follows. When the ratio a/b exceeds 3.0, i.e., when the nickel content is increased, the thermal stability of the lithium transition metal complex oxide is significantly degraded, resulting in a decrease in heat peak temperature and significant deterioration of safety. In contrast, when the ratio a/b is less than 0.7, the manganese content is increased, an impurity layer is generated, and thus the capacity is decreased. In particular, in order to enhance thermal stability and suppress the decrease in capacity, 0.7≦a/b≦1.5 is more preferably satisfied.

A reason for using a lithium transition metal complex oxide in which x in lithium content (1+x) satisfies 0<x≦0.1 is as follows. When 0<x is satisfied, the output characteristics are improved. Conversely, when x>0.1, the amount of alkali remaining on the surface of the lithium transition metal complex oxide is increased, a slurry used in preparing a battery undergoes gelling, and the capacity also decreases due to a decrease in the amount of transition metal used for redox reactions. More preferably, 0.05≦x≦0.1 and most preferably 0.07≦x≦0.1.

In the lithium transition metal complex oxide described above, d in the oxygen content (2+d) satisfies −0.1≦d≦0.1. This is to prevent damage on the crystal structure that occurs when the lithium transition metal complex oxide suffers oxygen deficiency or oxygen excess.

The lithium transition metal complex oxide may contain at least one element selected from the group consisting of boron (B), fluorine (F), magnesium (Mg), aluminum (Al), titanium (Ti), chromium (Cr), vanadium (V), iron (Fe), copper (Cu), zinc (Zn), niobium (Nb), molybdenum (Mo), zirconium (Zr), tin (Sn), tungsten (W), sodium (Na), and potassium (K).

When at least one niobium-containing material selected from a Li—Nb—O compound and a Li—Ni—Nb—O compound is sintered onto surfaces of positive electrode active material particles composed of lithium transition metal complex oxide having a layered structure containing nickel and manganese as main components as in the present invention, the interface between the positive electrode active material and the nonaqueous electrolyte solution is modified by sintered niobium, thereby accelerating charge transfer reactions. This is considered to result in improved output characteristics under various temperature conditions. Presumably, niobium sintered onto the surfaces of the positive electrode active material particles selectively acts on nickel, in particular, Ni²⁺, contained in the lithium transition metal complex oxide and decreases the resistance at the interface between the positive electrode and the nonaqueous electrolyte solution, thereby improving the output characteristics.

The Li—Nb—O compound and the Li—Ni—Nb—O compound sintered onto the surfaces of the positive electrode active material particles are not particularly limited. Examples of the Li—Nb—O compound include LiNbO₃, LiNb₃O₈, Li₂Nb₈O₂₁, Li₃NbO₄, and Li₇NbO₆. Examples of the Li—Ni—Nb—O compound include Li₃Ni₂NbO₆. The intermediate products of these may also be used.

In forming the niobium-containing compound sintered onto the positive electrode active material particles composed of the lithium transition metal complex oxide, the effects and advantages brought by niobium cannot be sufficiently obtained if the amount of niobium is excessively small. In contrast, when the amount of niobium is excessively large, the niobium-containing material having no electrical conductivity widely covers the surface of the lithium transition metal complex oxide (the coated regions become excessively large) and thus the charge/discharge characteristics of the battery are degraded. Accordingly, the positive electrode active material of the present invention preferably contains 0.05 mass % to 2.00 mass % of niobium and more preferably 0.20 mass % to 1.50 mass % of niobium.

When the size of the positive electrode active material particles is large, the discharge performance is degraded. When the size of the positive electrode active material particles is small, the reactivity to the nonaqueous electrolyte solution increases and the storage characteristics and the like are lowered. Thus, primary particles of the positive electrode active material particles are preferably 0.5 μm to 2 μm in terms of volume-average particle size and secondary particles are preferably 4 μm to 15 μm in terms of volume-average particle size.

The positive electrode active material of the present invention can be produced by, for example, performing a step of obtaining positive electrode active material particles composed of a lithium transition metal complex oxide having a layered structure containing at least nickel and manganese by primary baking and a step of subjecting a mixture of the positive electrode active material particles and a niobium-containing material to secondary baking at a temperature lower than that of the primary baking so as to form at least one niobium-containing material selected from a Li—Nb—O compound and a Li—Ni—Nb—O compound sintered onto surfaces of the positive electrode active material particles.

In obtaining positive electrode active material particles composed of a lithium transition metal complex oxide having a layered structure containing at least nickel and manganese by primary baking, a Li compound and a transition metal complex hydroxide or a transition metal complex oxide are combined as raw materials and the mixture is baked (primary baking) at an adequate temperature.

The type of Li compound used as the raw material of the positive electrode active material particles is not particularly limited. For example, at least one selected from the group consisting of lithium hydroxide, lithium carbonate, lithium chloride, lithium sulfate, lithium acetate, and hydrates of these may be used. The baking temperature for the primary baking differs depending on the composition of the transition metal complex hydroxide or the transition metal complex oxide, the particle size, etc., and it is difficult to independently determine the baking temperature. The baking temperature is usually in the range of 700° C. to 1100° C. and preferably 800° C. to 1000° C.

In forming at least one niobium-containing material selected from a Li—Nb—O compound and a Li—Ni—Nb—O compound sintered onto surfaces of the positive electrode active material particles by secondary baking of the mixture of the positive electrode active material particles and a niobium-containing compound at a temperature lower than that of the primary baking, for example, the positive electrode active material particles and a particular amount of a niobium-containing material may be mixed by a mechanofusion technique or the like so that the niobium-containing material adheres to the surfaces of the positive electrode active material particles, followed by secondary baking to conduct sintering.

The type of the niobium-containing compound mixed with the positive electrode active material particles is not particularly limited. For example, at least one selected from the group consisting of niobium fluoride, niobium chloride, niobium bromide, niobium iodide, niobium nitride, niobium carbide, niobium silicide, and niobium aluminide may be used. Oxides such as niobium oxide and lithium niobate are more preferably used in order to prevent inclusion of impurities other than lithium and niobium in the positive electrode active material.

As described above, it is difficult to independently define the temperature of the secondary baking of a mixture containing the positive electrode active material particles and the niobium-containing material since the temperature depends on the composition of the transition metal, shape, and particle size of the positive electrode active material particles and the type, shape, and particle size of the niobium-containing material, etc. However, the secondary baking temperature is lower than the primary baking temperature and is usually in the range of 400° C. to 1000° C. and preferably 500° C. to 900° C.

A reason the temperature of the secondary baking is adjusted to be lower than that of the primary baking is as follows. If the secondary baking is performed at a temperature equal to or higher than the primary baking temperature, the niobium-containing material added is trapped inside the positive electrode active material particles, promoting growth of the positive electrode active material particles. As a result, the effect of modifying the interface between the positive electrode active material and the nonaqueous electrolyte solution caused by sintered niobium is reduced, the output characteristics are degraded, and the properties such as storage properties can no longer improved. If the secondary baking temperature is lower than 400° C., the positive electrode active material particles do not properly react with the niobium-containing material. This inhibits the niobium-containing material such as niobium oxide added from changing into a Li—Nb—O compound or a Li—Ni—Nb—O compound and thus the niobium-containing material remains as is on the surfaces of the positive electrode active material particles. Thus, the interface between the positive electrode active material and the nonaqueous electrolyte solution cannot be satisfactorily modified.

When a mixture of the positive electrode active material particles and the niobium-containing material is subjected to secondary baking at an appropriate temperature, a niobium-containing material such as a Li—Nb—O compound or Li—Ni—Nb—O compound becomes satisfactorily sintered onto the surfaces of the positive electrode active material particles. When observed with a scanning electron microscope (SEM), grains of the niobium-containing material can be found on the surfaces of the positive electrode active material particles. A peak attributable to the niobium-containing material can be detected by X-ray diffractometry (XRD) when the niobium content in the niobium-containing material is about 0.5 mol % relative to the total amount of the transition metals of the positive electrode active material.

Such a positive electrode active material is used in the positive electrode of a nonaqueous electrolyte secondary battery of the present invention that includes a positive electrode containing a positive electrode active material, a negative electrode containing a negative electrode active material, and a nonaqueous electrolyte solution prepared by dissolving a solute in a nonaqueous solvent.

Another positive electrode active material may be mixed with the aforementioned positive electrode active material and used in the nonaqueous electrolyte secondary battery of the present invention. This different positive electrode active material to be mixed is not particularly limited as long as lithium can be reversibly intercalated and released. Examples thereof include compounds having layered structures, spinel structures, and olivine structures in which reversible intercalation and release of lithium is possible while maintaining stable crystal structures.

The negative electrode active material used in the negative electrode of the nonaqueous electrolyte secondary battery of the present invention is not particularly limited as long as lithium can be reversibly occluded and released. Examples thereof include carbon materials, metal or alloy materials that alloy with lithium, and metal oxides. In view of the raw material cost, carbon materials are preferably used as the negative electrode active material. Examples thereof include natural graphite, artificial graphite, mesophase pitch-based carbon fiber (MCF), mesocarbon microbeads (MCMB), coke, hard carbon, fullerene, and carbon nanotubes. In particular, in view of improving the high-rate charge/discharge characteristics, a carbon material prepared by coating a graphite material with a low crystallinity carbon is preferably used in the negative electrode active material.

Known nonaqueous solvents generally used in nonaqueous electrolyte secondary batteries can be used as the nonaqueous solvent used in the nonaqueous electrolyte solution of the nonaqueous electrolyte secondary battery of the present invention. Examples of such a solvent include cyclic carbonates such as ethylene carbonate, propylene carbonate, butylene carbonate, and vinylene carbonate, and chain carbonates such as dimethyl carbonate, methyl ethyl carbonate, and diethyl carbonate. In particular, it is preferable to use a mixed solvent of a cyclic carbonate and a chain carbonate as a nonaqueous solvent having a high lithium ion conductivity, a low viscosity, and a low melting point. Preferably, the volume ratio of the cyclic carbonate to the chain carbonate in the mixed solvent is within the range of 2:8 to 5:5.

An ionic liquid may be used as the nonaqueous solvent of the nonaqueous electrolyte solution. The cationic species and the anionic species are not particularly limited. From the viewpoint of low viscosity, electrochemical stability, and hydrophobicity, the combination of a pyridinium cation, an imidazolium cation, or a quaternary ammonium cation as a cation and a fluorine-containing imide anion as an anion is particularly preferred.

Known lithium salts generally used in nonaqueous electrolyte secondary batteries may be used as the solute used in the nonaqueous electrolyte solution. Examples of the lithium salts include lithium salts containing at least one element selected from P, B, F, O, S, N, and Cl. In particular, lithium salts such as LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, LiAsF₆, and LiClO₄ and mixtures of these may be used. In particular, in order to enhance the high-rate charge/discharge characteristics and durability of the nonaqueous electrolyte secondary battery, LiPF₆ is preferably used.

The separator to be interposed between the positive electrode and the negative electrode of the nonaqueous electrolyte secondary battery of the present invention is not particularly limited as long as the separator prevents short-circuiting caused by the contact between the positive and negative electrodes and can be impregnated with a nonaqueous electrolyte, thereby yielding lithium ion conductivity. Examples thereof include polypropylene separators, polyethylene separators, and polypropylene-polyethylene multilayer separators.

According to the present invention, a positive electrode active material that includes positive electrode active material particles composed of a lithium transition metal complex oxide having a layered structure containing nickel and manganese as main components and at least one niobium-containing material selected from a Li—Nb—O compound and a Li—Ni—Nb—O compound, the at least one niobium-containing material being sintered onto surfaces of the positive electrode active material particles is used as the positive electrode active material for a nonaqueous electrolyte secondary battery. Thus, the interface between the positive electrode active material and the nonaqueous electrolyte solution is modified by the sintered niobium.

As a result, even when an inexpensive lithium transition metal complex oxide having a layered structure containing nickel and manganese as main components is used in a positive electrode active material of a nonaqueous electrolyte secondary battery, the charge transfer reactions at the interface between the positive electrode active material containing sintered niobium and the nonaqueous electrolyte solution are accelerated due to this modification. Accordingly, output characteristics under various temperature conditions are improved and the battery is suitable for use as a power supply for hybrid vehicles and the like.

### BRIEF DESCRIPTION OF THE SEVERAL VIEWS OF THE DRAWINGS

FIG. 1 is a schematic diagram showing a state in which a niobium-containing material is sintered onto a positive electrode active material particle according to the present invention;

FIG. 2 is a schematic diagram of a conventional example in which a niobium-containing material is simply adhered onto a positive electrode active material particle;

FIG. 3 shows a state of a positive electrode active material prepared in Example 1 observed with a scanning electron microscope (SEM);

FIG. 4 is a schematic view showing a three-electrode test cell in which a positive electrode prepared in Examples and Comparative Examples is used as a working electrode;

FIG. 5 shows a state of a positive electrode active material prepared in Example 2 observed with SEM;

FIG. 6 shows a state of a positive electrode active material prepared in Comparative Example 2 observed with SEM;

FIG. 7 shows a state of a positive electrode active material prepared in Comparative Example 3 observed with SEM; and

FIG. 8 shows a state of a positive electrode active material prepared in Comparative Example 4 observed with SEM.

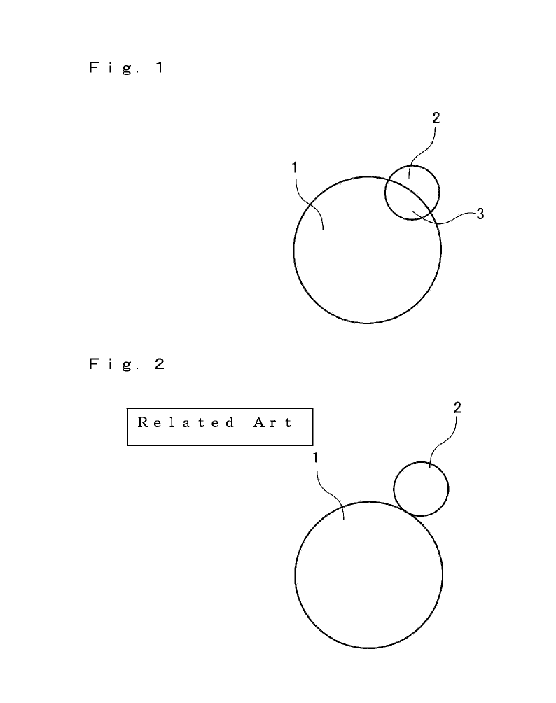

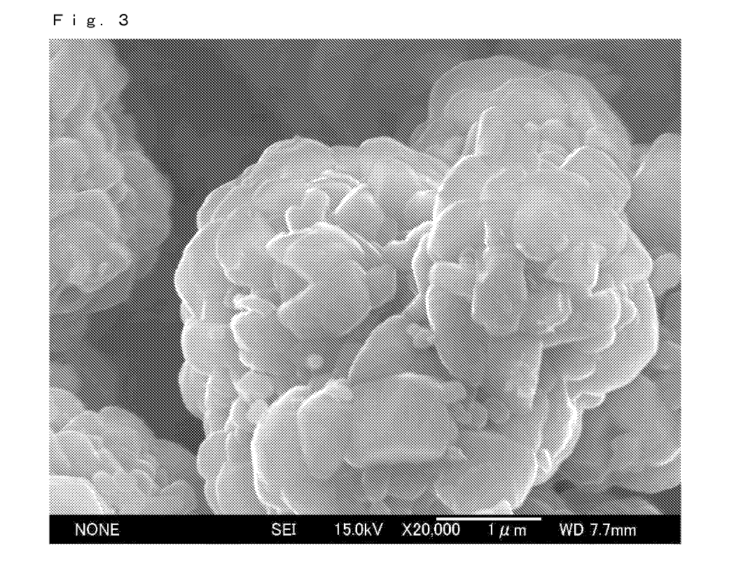

### DETAILED DESCRIPTION OF THE INVENTION

### Examples

The positive electrode active material for the nonaqueous electrolyte secondary battery and the nonaqueous electrolyte secondary battery according to the present invention will now be described in detail by using Examples. Comparative Examples are also described to show that the nonaqueous electrolyte secondary batteries that use positive electrode active materials of Examples have improved output characteristics under various temperature conditions. Note that the positive electrode active material of the nonaqueous electrolyte secondary battery and the nonaqueous electrolyte secondary battery of the present invention are not limited to Examples described below. Various modifications and alterations are possible without departing from the scope of the present invention.

### Example 1

In making a positive electrode active material of Example 1, positive electrode active material particles composed of lithium transition metal complex oxide having a layered structure containing nickel and manganese as main components were prepared by mixing LiOH and Ni_{0.60}Mn_{0.40}(OH)₂ obtained by a coprecipitation method in a particular ratio and then subjecting the mixture to primary baking at 1000° C. in air, thereby giving positive electrode active material particles composed of Li_{1.06}Ni_{0.56}Mn_{0.38}O₂ having a layered structure. The volume-average particle size of the primary particles of the obtained positive electrode active material particles composed of Li_{1.06}Ni_{0.56}Mn_{0.38}O₂ was about 1 μm and the volume-average particle size of the secondary particles was about 7 μm.

After mixing the positive electrode active material particles composed of Li_{1.06}Ni_{0.56}Mn_{0.38}O₂ with Nb₂O₅ having an average particle size of 150 nm in a particular ratio, the mixture was subjected to secondary baking for 1 hour at 700° C. to prepare a positive electrode active material composed of positive electrode active material particles having surfaces on which a niobium-containing oxide was sintered. The niobium content in the positive electrode active material thus prepared was 0.90 mass %.

The positive electrode active material prepared as above was observed with a scanning electron microscope (SEM). The result is shown in FIG. 3.

The positive electrode active material was also studied using an energy dispersive X-ray fluorescence spectrometer (EDX). It was found that fine particles composed of a niobium-containing oxide having an average size of about 150 nm were sintered and adhered onto the surfaces of the positive electrode active material particles composed of Li_{1.06}Ni_{0.56}Mn_{0.38}O₂.

The positive electrode active material particles onto which the fine particles of the niobium-containing oxide were sintered and adhered were analyzed by X-ray diffractometry (XRD). As a result, peaks attributable to Nb₂O₅ were not confirmed but peaks attributable to LiNbO₃ generated by the reaction between Nb₂O₅ and Li on the surfaces of the positive electrode active material particles were confirmed. It was thus found that the niobium-containing oxide was LiNbO₃.

The positive electrode active material, vapor grown carbon fiber (VGCF) serving as a conducting agent, and an N-methyl-2-pyrrolidone solution in which polyvinylidene fluoride serving as a binder was dissolved were prepared so that the mass ratio of the positive electrode active material to the conducting agent to the binder was 92:5:3 and kneaded to make a positive electrode mix slurry. The slurry was applied on a positive electrode collector formed of an aluminum foil, dried, and rolled with a roller. A collector tab composed of aluminum was attached to the foil to form a positive electrode.

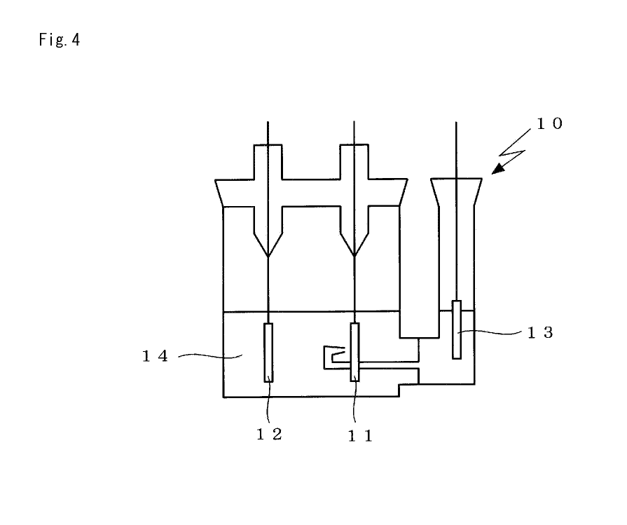

Then as shown in FIG. 4, the positive electrode was used as a working electrode 11. Metallic lithium was used in a counter electrode 12 functioning as a negative electrode and in a reference electrode 13. A nonaqueous electrolyte solution 14 was prepared by dissolving LiPF₆ in a mixed solvent containing ethylene carbonate, methyl ethyl carbonate, and dimethyl carbonate at a volume ratio of 3:3:4 so that the LiPF₆ concentration was 1 mol/l and further dissolving 1 mass % of vinylene carbonate in the resulting solution. A three-electrode test cell was fabricated using these components.

### Example 2

In Example 2, a positive electrode active material was fabricated as in Example 1 except that the secondary baking temperature at which a mixture of the positive electrode active material particles composed of Li_{1.06}Ni_{0.56}Mn_{0.38}O₂ and Nb₂O₅ having an average particle size of 150 nm was baked in air was set to 850° C. A three-electrode test cell of Example 2 was prepared as in Example 1 by using the positive electrode active material thus prepared.

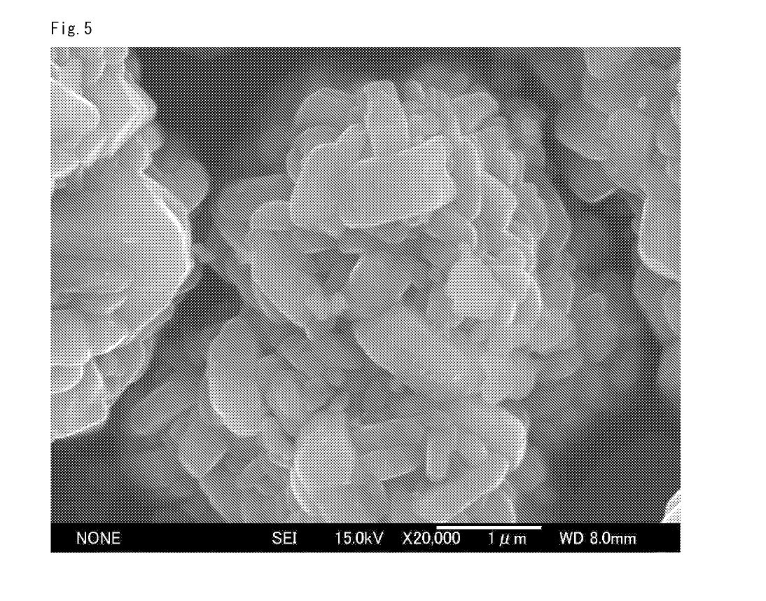

The positive electrode active material prepared as above was also observed with a scanning electron microscope (SEM). The result is shown in FIG. 5.

The positive electrode active material was also investigated using an energy dispersive X-ray fluorescence spectrometer (EDX). It was found that fine particles composed of a niobium-containing oxide having an average size of about 150 nm were sintered and adhered onto the surfaces of the positive electrode active material particles composed of Li_{1.06}Ni_{0.56}Mn_{0.38}O₂.

The positive electrode active material particles onto which the fine particles of the niobium-containing oxide were sintered and adhered were analyzed by X-ray diffractometry (XRD). As a result, peaks attributable to Nb₂O₅ were not confirmed but peaks attributable to Li₃Ni₂NbO₆ generated by the reaction between Nb₂O₅ and Li and Ni on the surfaces of the positive electrode active material particles were confirmed. It was thus found that the niobium-containing oxide was Li₃Ni₂NbO₆.

### Comparative Example 1

In Comparative Example 1, a three-electrode test cell of Comparative Example 1 was fabricated as in Example 1 except that the positive electrode active material particles composed of Li_{1.06}Ni_{0.56}Mn_{0.38}O₂ were not mixed with Nb₂O₅ but were directly used as the positive electrode active material.

### Comparative Example 2

In Comparative Example 2, a positive electrode active material was fabricated as in Example 1 except that the positive electrode active material particles composed of Li_{1.06}Ni_{0.56}Mn_{0.38}O₂ were mixed with Nb₂O₅ having an average size of 150 nm but the mixture was not subjected to secondary baking in air. A three-electrode test cell of Comparative Example 2 was prepared as in Example 1 by using the positive electrode active material thus prepared.

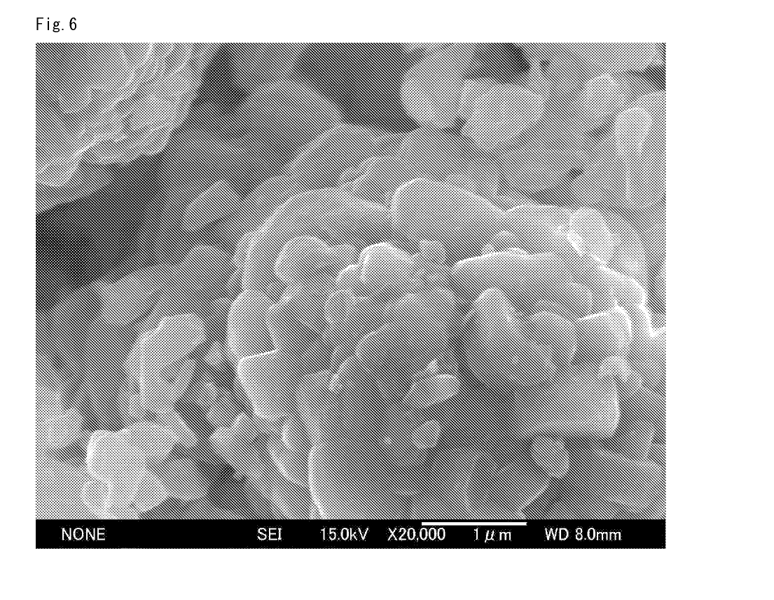

The positive electrode active material prepared as above was observed with a scanning electron microscope (SEM). The result is shown in FIG. 6.

The positive electrode active material was investigated using an energy dispersive X-ray fluorescence spectrometer (EDX). It was found that fine particles composed of a niobium-containing oxide having an average size of about 150 nm were sintered and adhered onto the surfaces of the positive electrode active material particles composed of Li_{1.06}Ni_{0.56}Mn_{0.38}O₂.

The positive electrode active material particles onto which the fine particles of the niobium-containing oxide were sintered and adhered were analyzed by X-ray diffractometry (XRD). As a result, only the peaks attributable to Nb₂O₅ were confirmed. It was thus found that the niobium-containing oxide was Nb₂O₅.

### Comparative Example 3

In Comparative Example 3, a positive electrode active material was fabricated as in Example 1 except that the secondary baking temperature at which a mixture of the positive electrode active material particles composed of Li_{1.06}Ni_{0.56}Mn_{0.38}O₂ and Nb₂O₅ having an average particle size of 150 nm was baked in air was set to 400° C. A three-electrode test cell of Comparative Example 3 was prepared as in Example 1 by using the positive electrode active material thus prepared.

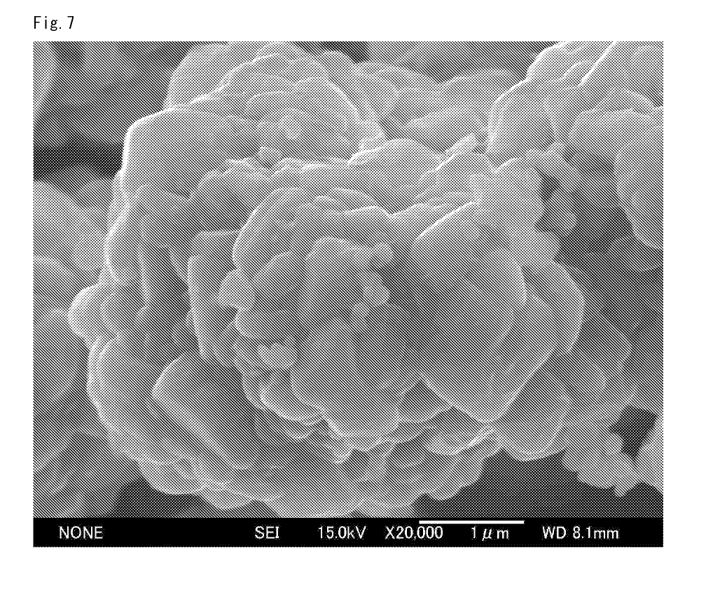

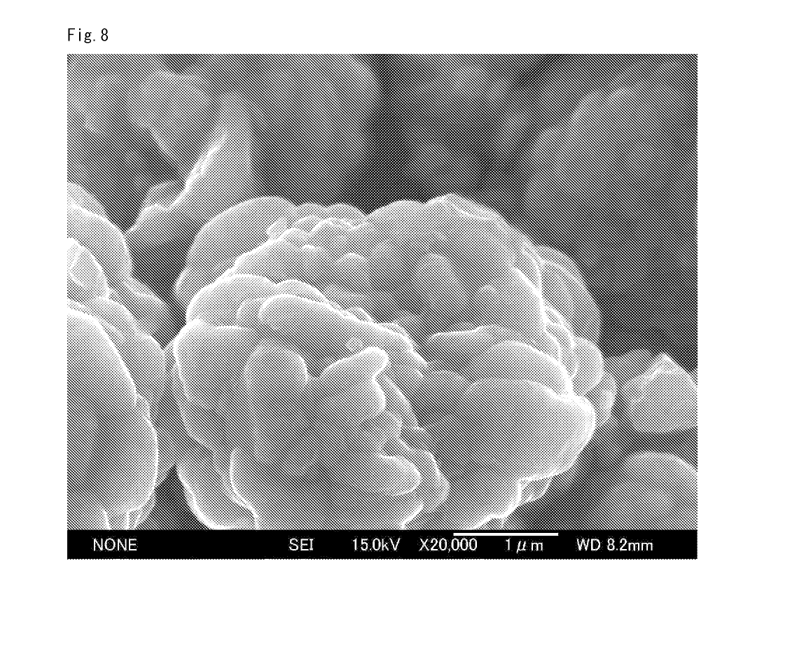

The positive electrode active material prepared as above was observed with a scanning electron microscope (SEM). The result is shown in FIG. 7.

The positive electrode active material was investigated using an energy dispersive X-ray fluorescence spectrometer (EDX). It was found that fine particles composed of a niobium-containing oxide having an average size of about 150 nm were sintered and adhered onto the surfaces of the positive electrode active material particles composed of Li_{1.06}Ni_{0.56}Mn_{0.38}O₂.

The positive electrode active material particles onto which the fine particles of a niobium-containing oxide were sintered and adhered were analyzed by X-ray diffractometry (XRD). As a result, only the peaks attributable to Nb₂O₅ were confirmed and peaks attributable to products of the reaction between Nb₂O₅ and Li on the surfaces of the positive electrode active material particles were not confirmed. It was thus found that the niobium-containing oxide was Nb₂O₅.

### Comparative Example 4

In Comparative Example 4, a positive electrode active material was fabricated as in Example 1 except that the secondary baking temperature at which a mixture of the positive electrode active material particles composed of Li_{1.06}Ni_{0.56}Mn_{0.38}O₂ and Nb₂O₅ having an average particle size of 150 nm was baked in air was set to 1000° C. A three-electrode test cell of Comparative Example 4 was prepared as in Example 1 by using the positive electrode active material thus prepared.

The positive electrode active material prepared as above was studied with a scanning electron microscope (SEM) and an energy dispersive X-ray fluorescence spectrometer (EDX). The result observed with SEM is shown in FIG. 8. The study found that the positive electrode active material had no fine particles of a niobium-containing oxide adhered onto the surfaces of the positive electrode active material particles composed of Li_{1.06}Ni_{0.56}Mn_{0.38}O₂.

The positive electrode active material was analyzed by X-ray diffractometry (XRD). As with Example 2 described above, peaks attributable to Li₃Ni₂NbO₆ generated by the reaction between Nb₂O₅ and Li and Ni of the positive electrode active material particles were confirmed.

Thus, it can be assumed that the positive electrode active material of Comparative Example 4 includes positive electrode active material particles with niobium dissolved therein, thereby forming Li₃Ni₂NbO₆.

Each of the three-electrode test cells of Examples 1 and 2 and Comparative Examples 1 to 4 was subjected to constant-current charging at 25° C. and current density of 0.2 mA/cm² up to 4.3 V (v. Li/Li⁺) and to constant-voltage charging at 4.3 V (v. Li/Li⁺) up to a current density of 0.04 mA/cm². Then constant-current discharging was conducted at a current density of 0.2 mA/cm² until the voltage was 2.5 V (vs. Li/Li⁺). The discharge capacity observed during this discharge was assumed to be the rated capacity of each three-electrode test cell.

Next, each of the three-electrode test cells was charged up to 50% of the rated capacity, i.e., 50% SOC (state of charge), and the output was measured by discharging the three-electrode test cell at 25° C. and at −30° C.

While assuming the output of the three-electrode test cell of Comparative Example 1 using a positive electrode active material not containing Nb₂O₅ to be 100 under each temperature condition, the output characteristics of the three-electrode test cells of Examples 1 and 2 and Comparative Examples 1 to 4 were calculated. The results are shown in Table 1.

Upon completion of the measurement of the output characteristics, each of the three-electrode test cells was subjected to constant-current charging at 25° C. and a current density of 0.2 mA/cm² up to 4.3 V (v. Li/Li⁺) and to constant-voltage charging at 4.3 V (v. Li/Li⁺) up to a current density of 0.04 mA/cm². Then the three-electrode test cells were stored in a thermostatic oven at 60° C. for 20 days.

Next, each of the three-electrode test cells stored as such was subjected to constant-current discharge at a current density of up to 0.2 mA/cm² until the voltage was 2.5 V (vs. Li/Li⁺). Then the three-electrode test cells were charged up to 50% of the rated capacity, i.e., 50% SOC (state of charge), and the output was measured by discharging the three-electrode test cells at 25° C. and at −30° C.

As with the case described above, the output of the three-electrode test cell of Comparative Example 1 using a positive electrode active material not containing Nb₂O₅ was assumed to be 100 under each temperature condition. Under this assumption, the output characteristics of the three-electrode test cells of Examples 1 and 2 and Comparative Examples 1 to 4 after storage were calculated. The results are shown in Table 1.

TABLE 1

| | Positive electrode active material | | | | | | | | | |
|---|---|---|---|---|---|---|---|---|---|---|
| | | Baking | | | | | Output characteristics | | | |
| | | temperature | | Niobium | | | at SOC 50% | | | |
| | | (° C.) | | Content | | State of | Before storage | | After storage | |
| | Composition | Primary | Secondary | (mass %) | Composition | presence | 25° C. | −30° C. | 25° C. | −30° C. |
| Example 1 | Li_{1.06}Ni_{0.56}Mn_{0.38}O₂ | 1000 | 700 | 0.9 | LiNbO₃ | Particle | 107 | 130 | 108 | 117 |
| | | | | | | surface | | | | |
| Example 2 | Li_{1.06}Ni_{0.56}Mn_{0.38}O₂ | 1000 | 850 | 0.9 | Li₃Ni₂NbO₆ | Particle | 138 | 143 | 132 | 142 |
| | | | | | | surface | | | | |
| Comparative | Li_{1.06}Ni_{0.56}Mn_{0.38}O₂ | 1000 | — | — | — | — | 100 | 100 | 100 | 100 |
| Example 1 | | | | | | | | | | |
| Comparative | Li_{1.06}Ni_{0.56}Mn_{0.38}O₂ | 1000 | — | 0.9 | Nb₂O₅ | Particle | 96 | 104 | 102 | 104 |
| Example 2 | | | | | | surface | | | | |
| Comparative | Li_{1.06}Ni_{0.56}Mn_{0.38}O₂ | 1000 | 400 | 0.9 | Nb₂O₅ | Particle | 102 | 95 | 101 | 98 |
| Example 3 | | | | | | surface | | | | |
| Comparative | Li_{1.06}Ni_{0.56}Mn_{0.38}O₂ | 1000 | 1000 | 0.9 | Li₃Ni₂NbO₆ | Inside | 132 | 123 | 101 | 107 |
| Example 4 | | | | | | particle | | | | |

The results were compared between the three-electrode test cells of Examples 1 and 2 that use a positive electrode active material prepared by mixing a positive electrode active material particles composed of Li_{1.06}Ni_{0.56}Mn_{0.38}O₂, i.e., a lithium transition metal complex having a layered structure containing Ni and Mn as main components, with a niobium-containing material, Nb₂O₅, and performing secondary baking on the mixture so that a Li—Nb—O compound such as LiNbO₃ or a Li—Ni—Nb—O compound such as Li₃Ni₂NbO₆ was sintered on the surfaces of the positive electrode active material particles and the three-electrode test cell of Comparative Example 1 that uses a positive electrode active material prepared without adding a niobium-containing material, Nb₂O₅ to the positive electrode active material particles composed of Li_{1.06}Ni_{0.56}Mn_{0.38}O₂. The output characteristics of the three-electrode test cells of Examples 1 and 2 at 25° C. and −30° C. and an SOC (state of charge) of 50% were greatly improved compared to those of Comparative Examples in all instances, i.e., before storage and after storage in a thermostat oven at 60° C. for 20 days.

In contrast, the three-electrode test cell of Comparative Example 2 that uses a positive electrode active material composed of a mere mixture of positive electrode active material particles composed of Li_{1.06}Ni_{0.56}Mn_{0.38}O₂ and a niobium-containing material, Nb₂O₅ and the three-electrode test cell of Comparative Example 3 that uses a positive electrode active material in which Nb₂O₅ added to the positive electrode active material particles composed of Li_{1.06}Ni_{0.56}Mn_{0.38}O₂ is adhered on the surfaces of the positive electrode active material particles but remains as is due to a low secondary baking temperature exhibit output characteristics nearly the same as those of the three-electrode test cell of Comparative Example 1 at 25° C. and −30° C. and a SOC (state of charge) of 50%. Therefore, no improvements were observed.

The three-electrode test cell of Comparative Example 4 uses a positive electrode active material in which niobium exists in the positive electrode active material particles by taking a form of Li_{1.06}Ni_{0.56}Mn_{0.38}O₂ because the secondary baking temperature at which a mixture of the positive electrode active particles composed of Li_{1.06}Ni_{0.56}Mn_{0.38}O₂ and the niobium-containing material, Nb₂O₅ was baked was excessively high, resulting in dissolution of niobium into the positive electrode active material particles. As with the three-electrode test cells of Examples 1 and 2, the output characteristics of such a three-electrode test cell of Comparative Example 4 at 25° C. and −30° C. and a SOC of 50% significantly improved compared to the three-electrode test cell of Comparative Example 1 before storage in a 60° C. thermostat oven for 20 days. However, after storage in the 60° C. thermostat oven for 20 days, the output characteristics of the three-electrode test cell of Comparative Example 4 were only about the same as those of the three-electrode test cell of Comparative Example 1. No improvements were observed in terms of output characteristics after storage. This is probably due to the following reason. When the secondary baking temperature is high, niobium becomes dissolved in the positive electrode active material particles and thereby forms Li₃Ni₂NbO₆. Thus, particles of a Li—Nb—O compound or a Li—Ni—Nb—O compound are not found on the surfaces of the positive electrode active material particles. Moreover, since niobium is dissolved by forming Li₃Ni₂NbO₆ and primary particles become coarse due to the growth of the positive electrode active material particles, the output characteristics after storage are degraded.

### Example 3

In Example 3, positive electrode active material particles were prepared by mixing Li₂CO₃ and a co-precipitated hydroxide represented by Ni_{0.5}CO_{0.2}Mn_{0.3}(OH)₂ in a particular ratio and baking the resulting mixture in air at 900° C. for 10 hours to obtain positive electrode active material particles composed of Li_{1.07}Ni_{0.46}CO_{0.19}Mn_{0.28}O₂ having a layered structure. The positive electrode active material particles were mixed with Nb₂O₅ having an average particle size of 150 nm, and the resulting mixture was subjected to secondary baking in air at 700° C. for 1 hour as in Example 1 to prepare a positive electrode active material. The volume-average particle size of the primary particles of the obtained positive electrode active material particles was about 1 μm and the volume-average particle size of the secondary particles was about 6 μm.

The positive electrode active material was investigated using a scanning electron microscope (SEM) and an energy dispersive X-ray fluorescence spectrometer (EDX). It was found that, as in Example 1, fine particles composed of a niobium-containing oxide having an average size of about 150 nm were sintered and adhered onto the surfaces of the positive electrode active material particles composed of Li_{1.07}Ni_{0.46}CO_{0.19}Mn_{0.28}O₂.

The positive electrode active material particles onto which the fine particles of the niobium-containing oxide were sintered and adhered were analyzed by X-ray diffractometry (XRD). As a result, peaks attributable to Nb₂O₅ were not confirmed but peaks attributable to LiNbO₃ generated by the reaction between Nb₂O₅ and Li on the surfaces of the positive electrode active material particles were confirmed. It was thus found that the niobium-containing oxide was LiNbO₃.

A three-electrode test cell of Example 3 was prepared as in Example 1 except that the positive electrode active material thus prepared was used.

### Example 4

In Example 4, a positive electrode active material was fabricated as in Example 3 except that the secondary baking temperature at which a mixture of the positive electrode active material particles composed of Li_{1.07}Ni_{0.46}CO_{0.19}Mn_{0.28}O₂ and Nb₂O₅ having an average particle size of 150 nm was baked in air was set to 850° C. A three-electrode test cell of Example 4 was prepared as in Example 3 by using the positive electrode active material thus prepared.

The positive electrode active material was investigated using a scanning electron microscope (SEM) and an energy dispersive X-ray fluorescence spectrometer (EDX). It was found that, as in Example 1, fine particles composed of a niobium-containing oxide having an average size of about 150 nm were sintered and adhered onto the surfaces of the positive electrode active material particles composed of Li_{1.07}Ni_{0.46}CO_{0.19}Mn_{0.28}O₂.

The positive electrode active material particles onto which the fine particles of the niobium-containing oxide were sintered and adhered was analyzed by X-ray diffractometry (XRD). As a result, peaks attributable to Nb₂O₅ were not confirmed but peaks attributable to Li₃Ni₂NbO₆ generated by the reaction between Nb₂O₅ and Li and Ni on the surfaces of the positive electrode active material particles were confirmed. It was thus found that the niobium-containing oxide was Li₃Ni₂NbO₆.

### Comparative Example 5

In Comparative Example 5, a three-electrode test cell of Comparative Example 5 was fabricated as in Example 3 except that the positive electrode active material particles composed of Li_{1.07}Ni_{0.46}CO_{0.19}Mn_{0.28}O₂ were not mixed with Nb₂O₅ but were directly used as the positive electrode active material.

Each of the three-electrode test cells of Examples 3 and 4 and Comparative Example 5 was subjected to constant-current charging at 25° C. and current density of 0.2 mA/cm² up to 4.3 V (vs. Li/Li⁺) and to constant-voltage charging at 4.3 V (vs. Li/Li⁺) up to a current density of 0.04 mA/cm². Then constant-current discharging was conducted at a current density of 0.2 mA/cm² until the voltage was 2.5 V (vs. Li/Li⁺). The discharge capacity observed during this discharge was assumed to be the rated capacity of each three-electrode test cell.

Next, each of the three-electrode test cells was charged up to 50% of the rated capacity, i.e., 50% SOC (state of charge), and the output was measured by discharging the three-electrode test cell at 25° C. and at −30° C. While assuming the output of a three-electrode test cell of Comparative Example 5 using a positive electrode active material not containing Nb₂O₅ to be 100 under each temperature condition, the output characteristics of the three-electrode test cells of Examples 3 and 4 and Comparative Example 5 were calculated. The results are shown in Table 2.

TABLE 2

| | Positive electrode active material | | | | | | | | | |
|---|---|---|---|---|---|---|---|---|---|---|
| | | Baking | | | | | Output characteristics | | | |
| | | temperature | | Niobium | | | at SOC 50% | | | |
| | | (° C.) | | Content | | State of | Before storage | | After storage | |
| | Composition | Primary | Secondary | (mass %) | Composition | presence | 25° C. | −30° C. | 25° C. | −30° C. |
| Example 3 | Li_{1.07}Ni_{0.46}Co_{0.19}Mn_{0.28}O₂ | 900 | 700 | 0.9 | LiNbO₃ | Particle | 106 | 132 | 106 | 150 |
| | | | | | | surface | | | | |
| Example 4 | Li_{1.07}Ni_{0.46}Co_{0.19}Mn_{0.28}O₂ | 900 | 850 | 0.9 | Li₃Ni₂NbO₆ | Particle | 117 | 167 | 126 | 154 |
| | | | | | | surface | | | | |
| Compara- | Li_{1.07}Ni_{0.46}Co_{0.19}Mn_{0.28}O₂ | 900 | — | — | — | — | 100 | 100 | 100 | 100 |
| tive | | | | | | | | | | |
| Example 5 | | | | | | | | | | |

The three-electrode test cells of Examples 3 and 4 each use a positive electrode active material prepared by performing secondary baking on a mixture of positive electrode active material particles composed of Li_{1.07}Ni_{0.46}CO_{0.19}Mn_{0.28}O₂ serving as a lithium transition metal complex oxide and Nb₂O₅ serving as a niobium-containing material so as to have a Li—Nb—O compound such as LiNbO₃ or a Li—Ni—Nb—O compound such as Li₃Ni₂NbO₆ sintered onto the surfaces of the positive electrode active material particles. In contrast, the three-electrode test cell of Comparative Example 5 uses a positive electrode active material prepared without adding a niobium-containing material, Nb₂O₅ to the positive electrode active material particles composed of Li_{1.07}Ni_{0.46}CO_{0.19}Mn_{0.28}O₂. When compared, the output characteristics of the three-electrode test cells of Examples 3 and 4 at 25° C. and −30° C. and an SOC of 50% showed improvements compared to that of Comparative Example 5 both before storage and after storage in a thermostat oven at 60° C. for 20 days.

### Comparative Example 6

In Comparative Example 6, positive electrode active material particles composed of Li_{1.02}Ni_{0.78}CO_{0.19}Al_{0.03}O₂ having a layered structure were prepared by mixing LiOH and a co-precipitated Ni_{0.78}CO_{0.19}Al_{0.03}(OH)₂ in a particular ratio and subjecting the resulting mixture to primary baking in an oxygen atmosphere at 750° C. for 20 hours. The volume-average particle size of the primary particles of the obtained positive electrode active material particles was about 1.0 μm and the volume-average particle size of the secondary particles was about 12.5 μm.

After mixing the positive electrode active material particles composed of Li_{1.02}Ni_{0.78}CO_{0.19}Al_{0.03}O₂ with Nb₂O₅ having an average particle size of 150 nm in a particular ratio, the mixture was subjected to secondary baking for 1 hour at 700° C. to prepare positive electrode active material composed of positive electrode active material particles having surfaces on which a niobium-containing oxide is sintered. The niobium content in the positive electrode active material thus prepared was 0.45 mass %.

The positive electrode active material was investigated using a scanning electron microscope (SEM) and an energy dispersive X-ray fluorescence spectrometer (EDX). It was found that fine particles composed of a niobium-containing oxide having an average size of about 150 nm were sintered and adhered onto the surface of the positive electrode active material particles composed of Li_{1.02}Ni_{0.28}CO_{0.19}Al_{0.03}O₂.

A three-electrode test cell of Comparative Example 6 was prepared as in Example 1 by using the positive electrode active material thus prepared.

### Comparative Example 7

In Comparative Example 7, a three-electrode test cell of Comparative Example 7 was prepared as in Comparative Example 6, i.e., as in Example 1, but by using positive electrode active material particles composed of Li_{1.02}Ni_{0.78}CO_{0.19}Al_{0.03}O₂ directly as a positive electrode active material without mixing Nb₂O₅.

Each of the three-electrode test cells of Comparative Example 6 and 7 was subjected to constant current charging at 25° C. and current density of 0.2 mA/cm² up to 4.3 V (v. Li/Li⁺) and to constant voltage charging at 4.3 V (v. Li/Li⁺) up to a current density of 0.04 mA/cm². Then constant-current discharging was conducted at a current density of 0.2 mA/cm² until the voltage was 2.5 V (vs. Li/Li⁺). The discharge capacity observed during this discharge was assumed to be the rated capacity of each three-electrode test cell.

Next, each of the three-electrode test cells was charged up to 50% of the rated capacity, i.e., 50% SOC (state of charge), and the output was measured by discharging the three-electrode test cell at 25° C.

While assuming the output of the three-electrode test cell of Comparative Example 7 using a positive electrode active material not containing Nb₂O₅ to be 100, the output characteristics of the three-electrode test cells of Comparative Examples 6 and 7 were calculated. The results are shown in Table 3.

TABLE 3

| | Positive electrode | | | | | | |
|---|---|---|---|---|---|---|---|
| | active material | | | | | | Output |
| | | Baking temperature | | Niobium | | | characteristics |
| | | (° C.) | | Content | | State of | at SOC 50% |
| | Composition | Primary | Secondary | (mass %) | Composition | presence | 25° C. |
| Comparative | Li_{1.02}Ni_{0.78}Co_{0.19}Al_{0.03}O₂ | 750 | 700 | 0.45 | LiNbO₃ | Particle | 98 |
| Example 6 | | | | | | surface | |
| Comparative | Li_{1.02}Ni_{0.78}Co_{0.19}Al_{0.03}O₂ | 750 | — | — | — | — | 100 |
| Example 7 | | | | | | | |

The results show that output characteristics of the three-electrode test cell of Comparative Example 6 that uses a lithium nickel complex oxide represented by Li_{1.02}Ni_{0.78}CO_{0.19}Al₀₀₃O₂ as the positive electrode active material particles and uses a positive electrode active material having fine particles of niobium-containing oxide sintered onto the surfaces of the positive electrode active material particles are substantially the same as those of the three-electrode test cell of Comparative Example 7 that uses a positive electrode active material composed of the positive electrode active material particles only.

It was thus found that the output characteristics are improved by using a positive electrode active material including positive electrode active material particles and fine particles of a niobium-containing material, such as a Li—Nb—O compound or a Li—Ni—Nb—O compound when a lithium transition metal complex oxide containing Ni and Mn as main components and having a layered structure was used in the positive electrode active material particles. In other words, this advantage is specific to when such a lithium transition metal complex oxide is used in the positive electrode active material particles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

1. A positive electrode active material for a nonaqueous electrolyte secondary battery, comprising:
positive electrode active material particles composed of a lithium transition metal complex oxide having a layered structure containing nickel and manganese as main components; and
at least one niobium-containing material selected from the group consisting of a Li—Nb—O compound and a Li—Ni—Nb—O compound,
wherein the at least one niobium-containing material is sintered onto surfaces of the positive electrode active material particles and forms a solid solution portion with the positive electrode active material particles.

2. The positive electrode active material according to claim 1, wherein the lithium transition metal complex oxide is represented by general formula Li₁₊ₓNiₐMn_{b}CO_{c}O_{2+d} (where x, a, b, c, and d satisfy x+a+b+c=1, 0.7≦a+b, 0<x≦0.1, 0≦c/(a+b)<0.40, 0.7≦a/b≦3.0, and −0.1≦d≦0.1).

3. The positive electrode active material according to claim 2, wherein a, b, and c in general formula Li₁₊ₓNiₐMn_{b}CO_{c}O_{2+d} satisfy 0≦c/(a+b)<0.35 and 0.7≦a/b≦2.0.

4. The positive electrode active material according to claim 3, wherein a, b, and c in general formula Li₁₊ₓNiₐMn_{b}CO_{c}O_{2+d} satisfy 0≦c/(a+b)<0.15 and 0.7≦a/b≦1.5.

5. The positive electrode active material according to claim 1, wherein a niobium content in the positive electrode active material is 0.05 mass % or more and 2.00 mass % or less.

6. The positive electrode active material according to claim 2, wherein a niobium content in the positive electrode active material is 0.05 mass % or more and 2.00 mass % or less.

7. The positive electrode active material according to claim 5, wherein the niobium content in the positive electrode active material is 0.20 mass % or more and 1.50 mass % or less.

8. The positive electrode active material according to claim 6, wherein the niobium content in the positive electrode active material is 0.20 mass % or more and 1.50 mass % or less.

9. The positive electrode active material according to claim 1, wherein primary particles of the positive electrode active material particles have a volume-average size of 0.5 μm or more and 2 μm or less and secondary particles of the positive electrode active material particles have a volume-average size of 4 μm or more and 15 μm or less.

10. The positive electrode active material according to claim 2, wherein primary particles of the positive electrode active material particles have a volume-average size of 0.5 μm or more and 2 μm or less and secondary particles of the positive electrode active material particles have a volume-average size of 4 μm or more and 15 μm or less.

11. The positive electrode active material according to claim 5, wherein primary particles of the positive electrode active material particles have a volume-average size of 0.5 μm or more and 2 μm or less and secondary particles of the positive electrode active material particles have a volume-average size of 4 μm or more and 15 μm or less.

12. The positive electrode active material according to claim 6, wherein primary particles of the positive electrode active material particles have a volume-average size of 0.5 μm or more and 2 μm or less and secondary particles of the positive electrode active material particles have a volume-average size of 4 μm or more and 15 μm or less.

13. A method for producing a positive electrode active material for a nonaqueous electrolyte secondary battery, the method comprising:
a step of obtaining positive electrode active material particles composed of a lithium transition metal complex oxide having a layered structure containing at least nickel and manganese by primary baking; and
a step of subjecting a mixture of the positive electrode active material particles and a niobium-containing material to secondary baking at a temperature lower than that of the primary baking so as to form at least one niobium-containing material selected from a Li—Nb—O compound and a Li—Ni—Nb—O compound sintered onto surfaces of the positive electrode active material particles,
wherein the positive electrode active material produced is the positive electrode active material according to claim 1.

14. A method for producing a positive electrode active material for a nonaqueous electrolyte secondary battery, the method comprising:
a step of obtaining positive electrode active material particles composed of a lithium transition metal complex oxide having a layered structure containing at least nickel and manganese by primary baking; and
a step of subjecting a mixture of the positive electrode active material particles and a niobium-containing material to secondary baking at a temperature lower than that of the primary baking so as to form at least one niobium-containing material selected from a Li—Nb—O compound and a Li—Ni—Nb—O compound sintered onto surfaces of the positive electrode active material particles,
wherein the positive electrode active material produced is the positive electrode active material according to claim 2.

15. A method for producing a positive electrode active material for a nonaqueous electrolyte secondary battery, the method comprising:
a step of obtaining positive electrode active material particles composed of a lithium transition metal complex oxide having a layered structure containing at least nickel and manganese by primary baking; and
a step of subjecting a mixture of the positive electrode active material particles and a niobium-containing material to secondary baking at a temperature lower than that of the primary baking so as to form at least one niobium-containing material selected from a Li—Nb—O compound and a Li—Ni—Nb—O compound sintered onto surfaces of the positive electrode active material particles,
wherein the positive electrode active material produced is the positive electrode active material according to claim 5.

16. A method for producing a positive electrode active material for a nonaqueous electrolyte secondary battery, the method comprising:
a step of obtaining positive electrode active material particles composed of a lithium transition metal complex oxide having a layered structure containing at least nickel and manganese by primary baking; and
a step of subjecting a mixture of the positive electrode active material particles and a niobium-containing material to secondary baking at a temperature lower than that of the primary baking so as to form at least one niobium-containing material selected from a Li—Nb—O compound and a Li—Ni—Nb—O compound sintered onto surfaces of the positive electrode active material particles,
wherein the positive electrode active material produced is the positive electrode active material according to claim 9.

17. A nonaqueous electrolyte secondary battery comprising:
a positive electrode including a positive electrode active material;
a negative electrode including a negative electrode active material; and
a nonaqueous electrolyte prepared by dissolving a solute in a nonaqueous solvent,
wherein the positive electrode active material according claim 1 is used as the positive electrode active material.

18. A nonaqueous electrolyte secondary battery comprising:
a positive electrode including a positive electrode active material;
a negative electrode including a negative electrode active material; and
a nonaqueous electrolyte prepared by dissolving a solute in a nonaqueous solvent,
wherein the positive electrode active material according claim 2 is used as the positive electrode active material.

19. A nonaqueous electrolyte secondary battery comprising:
a positive electrode including a positive electrode active material;
a negative electrode including a negative electrode active material; and
a nonaqueous electrolyte prepared by dissolving a solute in a nonaqueous solvent,
wherein the positive electrode active material according claim 5 is used as the positive electrode active material.

20. A nonaqueous electrolyte secondary battery comprising:
a positive electrode including a positive electrode active material;
a negative electrode including a negative electrode active material; and
a nonaqueous electrolyte prepared by dissolving a solute in a nonaqueous solvent,
wherein the positive electrode active material according claim 9 is used as the positive electrode active material.
